(19) United States
(12) Patent Application Publication
(10) Pub. No.: US 2006/0265590 A1
(43) Pub. Date: Nov. 23, 2006

(54) Digital signature/certificate for hard-copy documents

(76) Inventors: Dennis C. DeYoung, Webster, NY (US); Robert H. Sperry, Pittsford, NY (US)

Correspondence Address: Clifford P. Kelly;Alix, Yale & Ristas, LLP, 750 Main Street, Hartford, CT, 06103-2721, US

(21) Appl. No.: 11/131,641

(22) Filed: May 18, 2005

(51) Int. Cl. H04L 9/00

(52) U.S. Cl. 713/176; 713/175; 713/181

(57) ABSTRACT

A hard-copy authentication document is a physical manifestation of a digital signature or a physical manifestation of a public key affixed to a hard-copy document or physical object, respectively. A method of authentication and non-repudiation of hard-copy documents includes affixing a physical manifestation of a digital signature to a hard-copy document. The physical manifestation of a digital signature is converted to an electronic digital signature, which is compared to a public key to authenticate the hard-copy document.

### BACKGROUND

This embodiment relates generally to the authentication and non-repudiation of hard-copy communications. More particularly, the present embodiment relates to an apparatus and method for the authentication and non-repudiation of hard-copy documents using a digital signature and/or a digital certificate distributed in a novel manner.

Many business activities require execution of various documents, typically by signature. Signing such documents serves a number of purposes. A signature authenticates a writing by identifying the signer with the signed document. In certain contexts, the signature expresses the signer's approval or authorization of the writing, or the signer's intention that it have legal effect. Such authentication also enables the receiver to prove to a third party, such as a judge, that the document was created by the purported sender. This latter ability prevents the sender from repudiating a genuine document, such as a promise to pay, by falsely claiming that it is a forgery created by the receiver. A signature on a written document often imparts a sense of clarity and finality to the transaction and may lessen the subsequent need to inquire beyond the face of a document. Negotiable instruments, for example, rely upon formal requirements, including a signature, for their ability to change hands with ease, rapidity, and minimal interruption. The act of signing a document calls to the signer's attention the legal significance of the signer's act, and thereby helps prevent inconsiderate engagements. Consequently, sound practice calls for transactions to be formalized in a manner which assures the parties of their validity and enforceability.

Until a few years ago, formalization generally involved documenting the transaction on paper and signing or authenticating the paper. Although the basic nature of transactions has not changed, business conditions have required an increasing reliance on digital documents. Ordinary digital documents lack the verifiable authenticity of paper documents in two respects. First, they can be forged by third parties claiming to be the purported sender, or be subjected to undetectable modification in transit. Second, a genuine document can later be repudiated by the actual sender, who may falsely claim that the document is a forgery created by the receiver.

Digital signatures have been used for some time on digital documents to provide the two main functions of an ink signature on a paper document, namely “authentication” and “non-repudiation”. Most digital signature schemes use public key cryptography to provide authentication and non-repudiation for transmitted data. Typical digital signatures created via an asymmetric key algorithm can be validated by anyone knowing the public-key of the sender.

### SUMMARY

There is provided a hard-copy authentication document comprising a physical manifestation of a digital signature or a physical manifestation of a public key affixed to a hard-copy document or physical object, respectively.

The physical manifestation of a digital signature or the physical manifestation of a public key may be a 2D barcode or a dataglyph. The physical manifestation of a public key may be a physical manifestation of a digital certificate including a public key.

There is also provided a method of authentication and non-repudiation of hard-copy documents comprising affixing a physical manifestation of a digital signature to a hard-copy document. The physical manifestation of a digital signature is converted to an electronic digital signature, which is compared to a public key to authenticate the hard-copy document.

Affixing a physical manifestation of a digital signature to a hard-copy document comprises inputting a digital copy of the hard-copy document into a secure hash function to produce a message digest. The message digest and a private key of the originator of the hard-copy document are input into a digital signature algorithm to generate an electronic digital signature. The electronic digital signature is input into a printing device to produce the physical manifestation of a digital signature, which is mounted to the hard-copy document. Affixing a physical manifestation of a digital signature to a hard-copy document may also comprise inputting additional information into the secure hash function, for example date, time originator's name, URL reference to an original version of the hard-copy document, or other metadata.

Inputting the electronic digital signature into a printing device to produce the physical manifestation of a digital signature and mounting the physical manifestation of a digital signature to the hard-copy document may comprise appending the electronic digital signature to the digital copy of the hard-copy document, to produce a combined file. The combined file is printed, producing the physical manifestation of the digital signature and the hard-copy document as a single document.

Inputting the electronic digital signature into a printing device to produce the physical manifestation of a digital signature and mounting the physical manifestation of a digital signature to the hard-copy document may comprise sequentially inputting the electronic digital signature and the digital copy of the hard-copy document to the printing device, where the physical manifestation of the digital signature is printed over the hard-copy document. Inputting the electronic digital signature into a printing device to produce the physical manifestation of a digital signature and mounting the physical manifestation of a digital signature to the hard-copy document may comprise sequentially inputting the electronic digital signature and the digital copy of the hard-copy document to the printing device, where the physical manifestation of the digital signature and the hard-copy document are sequentially printed as a single document. Inputting the electronic digital signature into a printing device to produce the physical manifestation of a digital signature and mounting the physical manifestation of a digital signature to the hard-copy document may comprise printing the physical manifestation of the digital signature on a label and mounting the label to the hard-copy document.

Converting the physical manifestation of a digital signature to an electronic digital signature comprises scanning the physical manifestation of the digital signature and the hard-copy document to produce a digital copy of the hard-copy document and an electronic digital signature.

Comparing the electronic digital signature to a public key to authenticate the hard-copy document comprises inputting the electronic digital signature and the originators public key into a digital signature algorithm to produce a decrypted message digest. The digital copy of the hard-copy document is input into a secure hash function to produce a test message digest and compared to the decrypted message. The message is authenticated if the test message digest is identical to the decrypted message digest.

The method also comprises affixing a physical manifestation of a public key or a physical manifestation of a digital certificate to a physical object to produce a hard-copy digital certificate. The hard-copy digital certificate is distributed to a recipient of the hard-copy document and the physical manifestation of a public key or the physical manifestation of a digital certificate is converted to an electronic public key or an electronic digital certificate, respectively. Converting the physical manifestation of a public key or the physical manifestation of a digital certificate to an electronic public key or an electronic digital certificate comprises scanning the physical manifestation of a public key or the physical manifestation of a digital certificate to produce an electronic public key or an electronic digital certificate.

### BRIEF DESCRIPTION OF THE DRAWINGS

The present embodiment may be better understood and its numerous objects and advantages will become apparent to those skilled in the art by reference to the accompanying drawings in which:

FIG. 1 is a schematic diagram of apparatus for creating a physical manifestation of the digital signature/digital certificate;

FIG. 2 is a flow diagram of a method for creating a physical manifestation of the digital signature/digital certificate;

FIG. 3 is a flow diagram of a method for authenticating a physical manifestation of the digital signature/digital certificate; and

FIG. 4 is a schematic diagram of a physical manifestation of a digital certificate.

### DETAILED DESCRIPTION

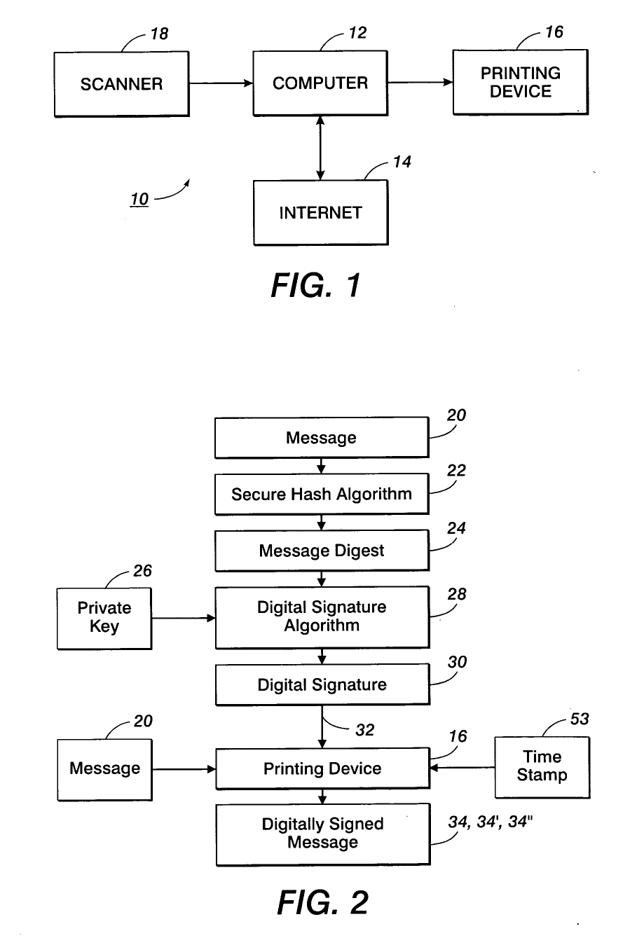

With reference to the drawings wherein like numerals represent like parts throughout the several figures, and more particularly to FIG. 1, there is shown an apparatus 10 for creating a digital signature/certificate for use on a hard-copy document. The apparatus 10 comprises a computer system 12, including a keyboard, a display and a mouse (none of which are shown), and is connected to the Internet 14. In addition, the computer system 12 includes a printing device 16 and a scanning device 18, as explained in greater detail below. It should be appreciated that the printing device 16 and the scanning device 18 may be parts of a multifunction device, such as a digital copier. It should also be appreciated that a digital camera may be used in place of the scanning device 18.

The subject method for creating and affixing a digital signature to a hard-copy document provides a signature that may be used to indicate the identity of the person who signed the document and that is very difficult for another person to produce without authorization. In addition, the digital signature may include information that can be used to identify or describe the document and to verify that the document has not been altered. Such signer authentication and document authentication are essential ingredients of a nonrepudiation service.

A conventional digital signature is a large number represented in a computer as a sequence of binary digits called bits. The digital signature is computed using a set of rules and a set of parameters such that the identity of the signatory and integrity of the data can be verified. The Digital Signature Standard (DSS) is a cryptographic standard promulgated by the National Institute of Standards and Technology (NIST) in 1994. It has been adopted as the federal standard for authenticating electronic documents, much as a written signature verifies the authenticity of a paper document. Each user possesses a private and public key pair. Public keys are assumed to be known to the public in general while private keys are never shared. Signature generation makes use of the private key to generate a digital signature. Signature verification makes use of the public key which corresponds to, but is not the same as, the private key. Anyone can verify the signature of a user by employing that user's public key. Signature generation can be performed only by the possessor of the user's private key.

With reference to FIG. 2, the document 20 that is to be digitally signed (hereinafter “the message”) is input into a secure hash function 22 to produce a condensed version of the message, hereinafter “the message digest” 24. The secure has function 22, the message digest 24 and the private key 26 are then input to the digital signature algorithm 28 to generate the digital signature 30. Other information, such as the time/date, the signer's name, a URL reference to an original version in a repository that may be under change management, or any other desired metadata may also be input to the digital signature algorithm 28 before the digital signature is generated. A physical manifestation of the digital signature is then affixed 32 to a hard-copy of the document. The term “physical manifestation of the digital signature” is hereby defined as a machine readable format bound to the document, such as through printing, having a capacity sufficient to display the complete data content of a digital signature meeting the criteria of applicable industry standards. One such physical manifestation is a printed representation of the digital signature in a 2D barcode. Two dimensional (2D) symbologies first appeared in 1988 when Code 49 was introduced by Intermec. Two dimensional barcodes can be classified into several types, with stacked and matrix being the most prevalent. Some of the advantages of 2D over one-dimensional (1 D) barcodes are the physical size, storage capability and data accuracy. One example of a 2D barcode is Adobe's PDF-417 2D barcode. Another such physical manifestation is a print of the digital signature in Xerox DataGlyphs™.

The task of affixing 32 a physical manifestation of the digital signature to a hard-copy of the document may be performed in a number of ways. The digital signature 30 may be appended to the message 20 and the combined files 20, 30 transmitted to the printing device 16, such that the message 20 and the physical manifestation of the digital signature are printed as a single document 34. Appending the digital signature 30 can be implemented as a plug-in to a document creation application, Microsoft Word for example, that allows you to add the digital signature 30 to a document or locate it on a sheet of paper and then combine it the with the original document 20 either by electronic or manual methods. The message 20 and digital signature 30 may be transmitted sequentially to the printing device 16. In this case, the message 20 and the physical manifestation of the digital signature may be printed as a single document 34, with the physical manifestation of the digital signature/document being overprinted on the document/physical manifestation of the digital signature, or as separate message and signature documents 34, with the signature document being physically appended to the message document. The physical manifestation of the digital signature 30 may be printed on a label that is then physically affixed to the document 34. The digital signature may also be used to manufacture a rubber stamp that is used to create the physical manifestation of the digital signature in a known manner. The message 20 and digital signature 30 may be stored in a portable memory device such as a floppy disc, a CD/DVD rom, a USB flash drive, or similar device, and transported to a printing device 16 that is physically and/or electronically separated from the computer system 12.

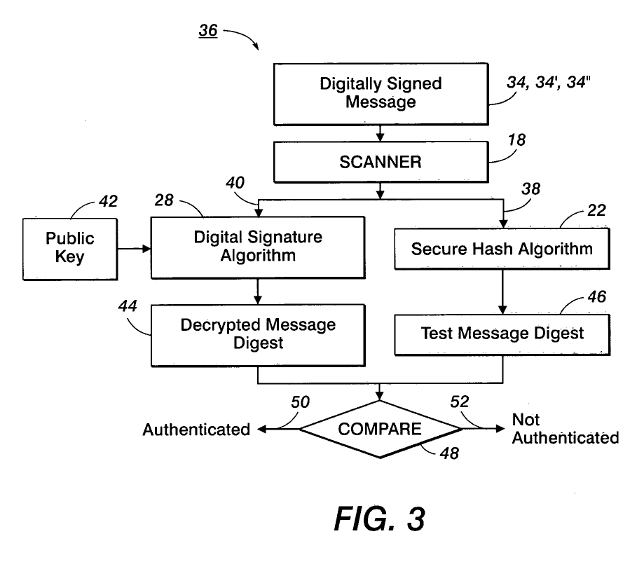

With reference to FIG. 3, the receiver authenticates 36 the digital signature 30 and the document 20 by scanning the physical manifestation of the digital signature and the document 34, 34′, 34″ to create a digital message file 38 and a digital signature file 40. The digital signature file 40 and the originators public key 42 are inputted into the digital signature algorithm 28, which decrypts the digital signature, producing a decrypted message digest 44. The receiver then inputs the digital message file 38 into the same hash function 22 as was used by the originator, to produce a test message digest 46. The review compares 48 the decrypted message digest 44 to the test message digest 46. If the test message digest 46 is identical to the decrypted message digest 44, the message is authenticated 50. If not, the message is not authenticated 52.

The document may also include a physical manifestation of a time stamp 53. The timing of a digital signature in relation to the operational period of a certificate is critical to the verification of the digital signature and message integrity. For example, a digital signature created after a certificate has expired, been revoked, suspended, or before it has been issued is not verifiable even if the certificate is or subsequently becomes valid. Similarly, the digital signature of a certification authority on a certificate issued by the certification authority must be created during the operational period of the certification authority certificate issued by the issuing authority higher in the hierarchy. A time-stamp on the certification authority's digital signature (or on the certificate or on internal auditable records of the certification authority) is thus critical to the verification of the certification authority's digital signature, and will also be a factor in determining the time and date when the certificate is issued, the beginning point of the certificate's operational period. A time-stamp 53 should be expressed in a form that clearly indicates its frame of reference so that time-stamps are universally comparable, notwithstanding different time zones and seasonal adjustments.

A digital certificate provides assurance that the public key is owned by the correct person or system with which an encryption or digital signature method will be used. This assurance is derived from a trusted third party or by a chain of trust to a trusted third party that has signed and distributed the digital certificate. One example of a digital certificate is a X.509 certificate, which conforms to the standards defined by the Internet Engineering Task Force (IETF). Examples of trusted third parties include such corporations as VeriSign and Thawte. Just as conventional digital signatures are electronic documents, conventional digital certificates are also electronic documents.

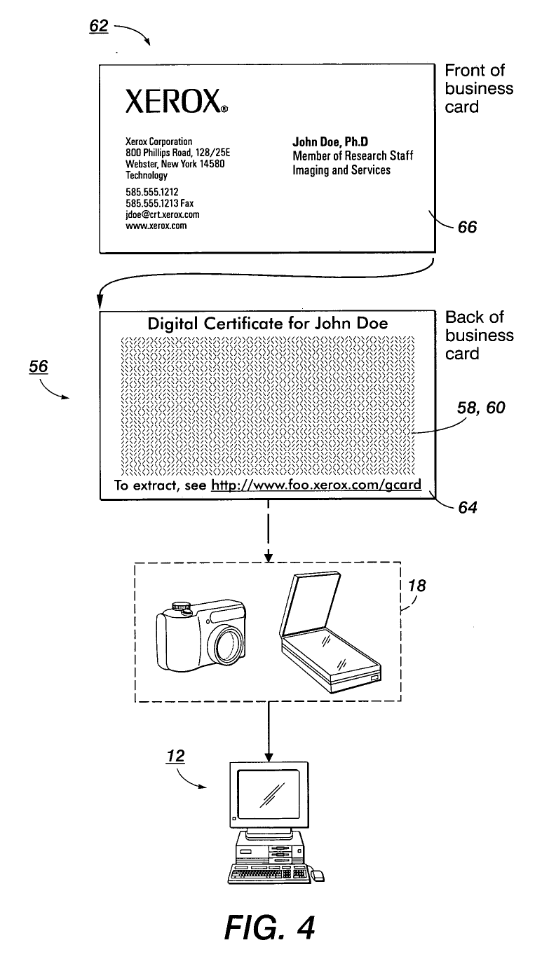

A hard-copy digital certificate 56 is shown in FIG. 4. The subject digital certificate is functionally equivalent to conventional digital certificates, for example digital certificates complying with X.509 requirements. A digital certificate is used to convey a public key associated with a specific user, and to certify the authenticity of the public key. Conventional digital certificates generally contain the user's name, a serial number, an expiration date, the digital signature of the certificate-issuing authority, and the user's public key. The subject hard-copy digital certificate 56 includes a physical manifestation of a public key 58 or a physical manifestation of a digital certificate 60. The terms “physical manifestation of a public key” 58 or “physical manifestation of the digital certificate” 60 is hereby defined as a machine readable format bound to a document, such as through printing, having a capacity sufficient to display the complete data content of a public key or a digital certificate meeting the criteria of applicable industry standards. Examples of such machine readable formats include 2D barcode and Xerox DataGlyphs™.

The subject hard-copy digital certificate 56 may be in the form of a business card 62, as shown in FIG. 4. In one variation, a physical manifestation of the user's public key 58 is affixed to the back 64 of the business card 62. The front 66 of the business card 62 includes other identification information on the user. For example, the user's name, address, telephone number, email address, etc. Trust in the physical manifestation of the public key 58 that is on the card is obtained from the trust of the individual from whom the business card 62 was received (e.g. If John Doe hands me his business card, I can trust that the physical manifestation of the public key on the back of the card is his). The physical manifestation of the public key 58 is converted back into a usable digital form by scanning or digitally photographing the business card back 64 and decoding the physical manifestation of the public key 58 on the card 62 to a file. The task of affixing a physical manifestation of the public key 58 to the business card 62 may be performed in the same manner described above for the digital signature.

In a second variation, a physical manifestation of a digital certificate 60 from a certificate-issuing authority is affixed to the back 64 of the business card 62. Using a physical manifestation of a digital certificate 60 provides a dual level of trust. First, there is the trust that is obtained from the trust of the individual from whom the business card 62 was received, as in the case of the business card described above. Second, there is the trust that is obtained by the use of digital certificate obtained from a certificate-issuing authority. The physical manifestation of the digital certificate 60 is converted back into a usable digital form by scanning the business card back 64 and decoding the physical manifestation of the digital certificate 60 on the card 62 to a file. The digital certificate thus obtained has additional utility, in that certain conventional software systems are set up to recognize and work with conventional digital certificates.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A hard-copy authentication document comprises a physical manifestation of at least one of a digital signature or a public key, the physical manifestation being affixed to a physical object.

2. The hard-copy authentication document of claim 1 wherein the physical manifestation of a digital signature or the physical manifestation of a public key comprises a 2D barcode.

3. The hard-copy authentication document of claim 2 wherein the physical manifestation of a digital signature or the physical manifestation of a public key comprises a dataglyph.

4. The hard-copy authentication document of claim 1 wherein the physical manifestation of a public key comprises a physical manifestation of a digital certificate, the digital certificate including a public key.

5. The hard-copy authentication document of claim 1 wherein the physical object includes a hard-copy document.

6. A method of authentication and non-repudiation of hard-copy documents comprising:
affixing a physical manifestation of a digital signature to a hard-copy document;
converting the physical manifestation of a digital signature to an electronic digital signature; and
validating the electronic digital signature with a public key to authenticate the hard-copy document.

7. The method of claim 6 wherein affixing a physical manifestation of a digital signature to a hard-copy document comprises:
inputting a digital copy of the hard-copy document into a secure hash function to produce a message digest;
inputting the message digest and a private key of an originator of the hard-copy document into a digital signature generation algorithm to generate an electronic digital signature;
inputting the electronic digital signature into a printing device to produce the physical manifestation of a digital signature; and
mounting the physical manifestation of a digital signature to the hard-copy document.

8. The method of claim 7 wherein affixing a physical manifestation of a digital signature to a hard-copy document also comprises inputting additional information into the digital signature generation algorithm, the information being selected from the group comprising date, time originator's name, document title, document version, URL reference to an original electronic version of the hard-copy document, or other metadata.

9. The method of claim 7 wherein inputting the electronic digital signature into a printing device to produce the physical manifestation of a digital signature and mounting the physical manifestation of a digital signature to the hard-copy document comprises:
appending the electronic digital signature to the digital copy of the hard-copy document, to produce a combined file, and inputting the combined file to the printing device; and
printing the physical manifestation of the digital signature and the hard-copy document as a single document.

10. The method of claim 7 wherein inputting the electronic digital signature into a printing device to produce the physical manifestation of a digital signature and mounting the physical manifestation of a digital signature to the hard-copy document comprises:
sequentially inputting the electronic digital signature and the digital copy of the hard-copy document to the printing device; and
printing the physical manifestation of the digital signature over the hard-copy document.

11. The method of claim 7 wherein inputting the electronic digital signature into a printing device to produce the physical manifestation of a digital signature and mounting the physical manifestation of a digital signature to the hard-copy document comprises:
sequentially inputting the electronic digital signature and the digital copy of the hard-copy document to the printing device; and
sequentially printing the physical manifestation of the digital signature and the hard-copy document as a single document.

12. The method of claim 7 wherein inputting the electronic digital signature into a printing device to produce the physical manifestation of a digital signature and mounting the physical manifestation of a digital signature to the hard-copy document comprises:
printing the physical manifestation of the digital signature on a label; and
mounting the label to the hard-copy document.

13. The method of claim 7 wherein inputting the electronic digital signature into a printing device to produce the physical manifestation of a digital signature and mounting the physical manifestation of a digital signature to the hard-copy document comprises:
opening the digital copy of the hard-copy document with a document creation program;
actuating a plug-in routine of the document creation program, the plug-in routine combining the electronic digital signature with the digital copy of the hard-copy document; and
initiating a print command of the document creation program to input the combined electronic digital signature and digital copy of the hard-copy document into the printing device.

14. The method of claim 7 wherein inputting the electronic digital signature into a printing device to produce the physical manifestation of a digital signature and mounting the physical manifestation of a digital signature to the hard-copy document comprises:
storing the digital copy of the hard-copy document and the electronic digital signature in a portable memory device;
transporting the portable memory device to the printing device; and
inputting the digital copy of the hard-copy document and the electronic digital signature into the printing device from the portable memory device.

15. The method of claim 7 wherein inputting the electronic digital signature into a printing device to produce the physical manifestation of a digital signature and mounting the physical manifestation of a digital signature to the hard-copy document comprises:
inputting the digital copy of the hard-copy document and the electronic digital signature into a stamp making device;
creating a stamp of the digital signature with the stamp making device; and
reproducing at least one physical manifestation of a digital signature with the stamp.

16. The method of claim 6 wherein converting the physical manifestation of a digital signature to an electronic digital signature comprises scanning the physical manifestation of the digital signature and the hard-copy document to produce a digital copy of the hard-copy document and an electronic digital signature.

17. The method of claim 16 wherein comparing the electronic digital signature to a public key to authenticate the hard-copy document comprises:
inputting the electronic digital signature and the originators public key into a digital signature generation algorithm to produce a decrypted message digest;
inputting the digital copy of the hard-copy document into a secure hash function to produce a test message digest; and
comparing the decrypted message digest to the test message digest;
wherein the message is authenticated if the test message digest is identical to the decrypted message digest.

18. The method of claim 6 further comprising:
affixing a physical manifestation of a public key or a physical manifestation of a digital certificate to a physical object to produce a hard-copy digital certificate;
distributing the hard-copy digital certificate to a recipient of the hard-copy document; and
converting the physical manifestation of a public key or the physical manifestation of a digital certificate to an electronic public key or an electronic digital certificate, respectively.

19. The method of claim 18 wherein converting the physical manifestation of a public key or the physical manifestation of a digital certificate to an electronic public key or an electronic digital certificate comprises scanning the physical manifestation of a public key or the physical manifestation of a digital certificate to produce an electronic public key or an electronic digital certificate.

20. A method of authentication and non-repudiation of documents comprising:
affixing a physical manifestation of a public key or a physical manifestation of a digital certificate to a physical object to produce a hard-copy digital certificate;
distributing the hard-copy digital certificate to a recipient of the document;
converting the physical manifestation of a public key or the physical manifestation of a digital certificate to an electronic public key or an electronic digital certificate, respectively; and
authenticating a digital signature with the electronic public key or the electronic digital certificate.

21. The method of claim 20 wherein affixing a physical manifestation of a public key or a physical manifestation of a digital certificate to a physical object to produce a hard-copy digital certificate comprises:
inputting a public key or a digital certificate into a printing device to produce the physical manifestation of a public key or a physical manifestation of a digital certificate; and
mounting the physical manifestation of a public key or the physical manifestation of a digital certificate to the physical object.

22. The method of claim 21 wherein the physical object is a piece of card stock having front and back sides, and wherein mounting the physical manifestation of a public key or the physical manifestation of a digital certificate to the physical object comprises printing the physical manifestation of a public key or the physical manifestation of a digital certificate on the back side of the card stock.

23. The method of claim 22 further comprising printing identification information of the originator on the front side of the card stock.

24. The method of claim 23 wherein the originator identification information is selected from the group comprising the originator's name, address, telephone number, email address, social security number, employee number, or account number.
